(19) United States
(12) Patent Application Publication
(10) Pub. No.: US 2024/0100749 A1
(43) Pub. Date: Mar. 28, 2024

(54) Cleaning system and cleaning method, and manufacturing device for workpieces

(71) Applicant: Kiefel GmbH, Freilassing (DE)

(72) Inventors: Matthias Hausmann, Unken (AT); Hubert Rehrl, Teisendorf (DE); Josef Rehrl, Teisendorf (DE)

(21) Appl. No.: 18/471,453

(22) Filed: Sep. 21, 2023

(30) Foreign Application Priority Data
Sep. 22, 2022 (DE) 10 2022 124 327.3

(51) Int. Cl. B29C 33/72; B08B 3/12; B08B 3/14

(52) U.S. Cl. CPC B29C 33/72; B08B 3/12; B08B 3/14

(57) ABSTRACT

The present disclosure relates to a cleaning system. The cleaning system may include a support and holding structure for the cleaning unit of at least one molding tool where the at least one molding tool includes at least one interior through which a flow can pass and at least one mold part having a plurality of openings. At least one inlet connection for a (cleaning) inlet line may be provided on the at least one molding tool, via which inlet connection a cleaning fluid can be introduced into at least one interior of the molding tool and can be discharged via the plurality of openings of the mold parts. A closure frame and a closure element may be provided where the closure frame is arranged between the at least one molding tool and the closure element to form a drain space.

### PRIORITY CLAIM

The present application claims priority under 35 U.S.C. § 119 to German Patent Application No. DE 10 2022 124 327.3, filed Sep. 22, 2022, the disclosure of which is incorporated by reference herein in its entirety.

### TECHNICAL FIELD

The present disclosure relates to a cleaning system, a manufacturing device for workpieces, and a cleaning method.

### DESCRIPTION OF RELATED ART

In the prior art, processes and plants are known for the production of workpieces and products made of fiber material or with portions of fiber materials from a pulp.

For example, WO 2021/73674 A2 discloses such a production line with a forming station for forming, a preforming station for preforming, a hot pressing station for final forming, of a workpiece made of environmentally compatible degradable fiber material in a fiber forming process.

An improved production plant and production process for this purpose is disclosed in WO 2021/073672 A1, in which additionally the application of a functional layer or a layer system of a plurality of functional layers and/or an application of a further layer of fiber material to a surface of the mold part to be coated is carried out.

With these basically very suitable manufacturing plants and processes, it has been shown that it is sometimes very time-consuming that regular cleaning of the forming tools is required, for which they have to be removed and cleaned manually in a time-consuming process.

It is an objective of the present disclosure to propose an improved production plant with regard to cleaning and improved method.

This objective may be achieved according to the present disclosure by a cleaning system, a manufacturing device and a cleaning method.

Advantageous embodiments are specified in the respective associated dependent claims.

The object is then achieved by a cleaning system which is suitable in particular for a forming unit for workpieces made of a starting material having fibers. This cleaning system includes:
at least one cleaning unit,
a support and holding structure for the cleaning unit,
at least one molding tool and/or a pair of complementary molding tools. The at least one molding tool has at least one through-flow interior and at least one mold part which has a plurality of openings and/or is designed in a sieve-like manner.

The molding tool can in particular have a group of mold parts or be formed entirely or partially therefrom. Furthermore, the at least one molding tool can be a pressing tool of a pressing station and/or a preforming tool of a preforming station. Furthermore, the molding tool can be provided as a tool both in the preforming station and in a pressing station, in particular as part of a movable and/or pivotable drive unit, such as for example a drive robot.

Furthermore, the cleaning system includes:
a pressing device, by means of which a force can be exerted on the molding tool, and wherein at least one inlet connection for a cleaning and/or inlet line is provided on the at least one molding tool, via which inlet connection a cleaning fluid can be introduced into at least one interior of the molding tool and can be discharged via the plurality of openings of the mold parts. In this case, a closure frame and a closure element are also provided, wherein the closure frame is arranged between the at least one molding tool and the closure element and together form a drain space. Furthermore, the closure frame and/or the closure element has a drain opening and/or a drain connection to drain off cleaning fluid. In this case, the pressing device is designed for the non-positive and sealing closure of the drain space and is operatively arranged in accordance with the force flow.

In a first step, the sealed drain space thus serves to receive the rinsing and/or cleaning fluid escaping from the interiors of the molding tools via the openings of the mold parts and to discharge it in a targeted manner, for example via a drain connection.

The interior of the molding tool can have a plurality of partial spaces and/or be designed as a channel system. In such an embodiment, the molding tool has either a plurality of inlet connections and/or an inner conduit system, so that at least one number or all of the subspaces can be charged with a cleaning fluid. In the following, for the sake of simplicity, only one interior is always referred to, but this is not to be understood as limiting.

The closure frame is at least three-sided, but is not to be understood as limiting. It can be formed from one piece or can be constructed from several side parts and/or layers. Furthermore, the closure frame can have suitable seals and suitable receiving regions and/or guides for sealing materials in order to create a fluid-tight drain space. The drain connection in the closure frame is also not to be understood restrictively and can be designed in any suitable connection geometry, in particular having form-fitting shapes, such as a tongue-and-groove arrangement.

Alternatively or additionally, the molding tool can also have a discharge channel which leads at least partially through the interior of the molding tool and/or runs in or on the wall of the molding tool. In this case, an inlet side of the discharge channel is arranged in the region of the drain space and the outlet side of the discharge channel and a suitable inlet connection are arranged on the outside of the molding tool. The advantage of this embodiment is that the molding tool can remain permanently connected to all inlet lines and only the closure frame has to be inserted as, for example, a circumferential four-sided frame element during the start of the cleaning method.

Alternatively, an advantageous embodiment can consist in that the closure frame has at least one inlet and one drain connection leading to the outside, wherein the inlet connection is connected in particular in the interior of the closure frame to a connecting line which can be connected to at least one inner inlet connection of the molding tool. The connecting line and the at least one inlet connection are, in particular designed as an interacting force-locking and/or form-fitting quick coupling unit. In this case, the molding tool has a closure element which closes the quick coupling unit and/or the connecting line, such as, for example, an overpressure valve. In this embodiment, the great advantage is that all connections can remain permanently on the closure frame, when the latter can be stored in the vicinity of the molding tools and is connected via correspondingly flexible and/or adjustable lines.

A particular advantage is that the molding tool that is present and movable for forming workpieces is used as a pressing tool to close the cleaning element in a fluid-tight manner, so that no additional (Press) devices for closing are required.

In an advantageous embodiment, the cleaning unit is substantially constructed from a molding tool, the closure frame and a closing closure element which has a simple end plate or closure trough. In an alternative embodiment, it can be provided that the closure frame and the plate-like or trough-like closure element form a fixed structural unit, in particular a fixedly connected structural unit, possibly welded and/or monolithically produced from a single material.

When the cleaning unit is closed by, for example, the pressing device, the bearing forces are to be selected such that they are slightly above the pressure in the interior of the molding tool and/or the drain space, which must also be ensured during cleaning by means of pressure shocks or pressure pulses.

In an improved embodiment, a cleaning unit can be provided comprising two complementary molding tools, wherein each of the two molding tools has at least one inlet connection for an inlet line, via which inlet connection a cleaning fluid can be introduced into at least one interior of the respective molding tool and can be discharged via the plurality of openings of the at least one mold part, and wherein both molding tools are provided with
in each case a closure frame and
in each case one or one common closure element and in each case form a drain space.

As described above, the closure element can in particular be a simple plate which then forms a separate drain space with the respective closure frame. The advantage of this embodiment is that each molding tool can be cleaned independently of the other molding tool.

All process media and process parameters can thus be selected independently. For example, if the geometrically smaller overall space consisting of the interior and drain space of the molding tool with the negatively formed mold elements is to be cleaned, a shorter cleaning time can be selected for this space than for the overall larger overall space consisting of the interior of the molding tool with the positively formed mold parts and the associated drain space. The analogous consideration applies in particular when a specific cleaning requirement and/or cleaning success is detected in advance and/or in parallel.

In this case, “positive mold parts” are understood to mean those mold parts which project away from the molding tool, that is to say project into the drain space, “negative mold parts” being understood to mean those mold parts which project into the (one) interior of the mold part, i.e. do not protrude into the drain space.

In a further improved embodiment, it can be provided that the cleaning unit has two complementary molding tools, wherein each of the two molding tools has at least one inlet connection for an inlet line, via which inlet connection a cleaning fluid can be introduced into at least one interior of the respective molding tool and can be discharged via the plurality of openings of the at least one mold part, and wherein the further molding tool functions as a closure element and the closure frame is arranged between the two molding tools.

In other words, no closure element is provided as a plate or trough, but rather the second, opposite molding tool represents the closure element.

Overall, an advantage can be that the pressing device with which the cleaning unit is closed in a fluid-tight manner is at least partially identical, for example on one side, to the pressing device by means of which the forming of one or a group of workpieces takes place in the production method of the workpieces.

As indicated above, it can be advantageous that only one side or part of the pressing device is used when, for example, only one molding tool or one side of a molding tool is to be cleaned and the latter is pressed against an external closure element or against a rigid support and closure structure, such as a table.

In an alternative embodiment, it can be provided that the pressing device is a mobile clamping and/or gripping unit, in particular a mobile clamping and/or gripping unit of a handling device, especially a robot.

This embodiment has the advantage that the production process only has to be briefly interrupted and/or the cleaning at a separate cleaning point within the production installation can take place, which is technically better suited, because there may be the necessary connections and/or safety precautions for handling hazardous chemical substances, such as the handling of highly concentrated acids or bases.

In other words, the molding tools are removed from the manufacturing device, ideally removed as a fully assembled cleaning unit which is transported to the cleaning site for automatic cleaning. The mobile clamping and/or gripping unit can be any transportable screw and/or clamping device in a non-limiting manner. In particular, the clamping and/or gripping unit can be part of a transfer unit, like a robot.

In this embodiment, there is an advantage that clean molding tools can be installed during the cleaning method and the manufacturing device must be stopped only for the short duration of removal.

In a further improved embodiment, it can be provided that the cleaning unit includes at least one ultrasound emitter, especially an ultrasound emitter which is arranged on the closure frame and/or on the molding tool.

Here, “arranged on” refers to any placement on a surface of an inner wall or interior. Cleaning by means of ultrasound emitters has proven to be very effective in particular for the removal of very hard adhesions, such as, for example, by hot pressing of burnt organic substances.

In a further improved embodiment, provision can be made for a conveying and pulse unit to be provided upstream of the cleaning unit. Advantageously, the interior of the molding tool and/or the inlet line (inlet line) of the cleaning fluid can be subjected to at least one pressure surge and/or a pressure pulse by means of the conveying and impulse unit.

In this case, the conveying and pulse unit can be a pump and, for example, can be identical to the feed pump for the cleaning fluid, which is controlled in a suitable manner. In this case, designs such as piston pumps are advantageous as positive displacement pumps.

Alternatively or additionally, the delivery and impulse unit can also be a gas or vapor expansion unit that discharges a pre-pressurized volume of gas or vapor into the inlet line or an interior of the molding tool via quick-closing valves.

Overall, it has been shown that a pressure pulse, in particular a plurality of pressure pulses, is particularly advantageous for the discharge of adhering fiber materials at greater than 3 bar, in particular greater than 5 bar.

It has further surprisingly been shown for the effectiveness of the pulse phase and the pressure pulses that the ratio of the flow cross sections in the inlet line and the drain line can be significant. Therefore, the flow cross section in the drain line should be greater than or equal to a factor of 0.8 of the flow cross section in the inlet line, in particular greater than or equal to 1, ideally greater than or equal to 1.2.

The sum of all flow cross sections, all inlet lines, and analogously the sum of all flow cross sections of all drain lines is meant with the flow cross section in the inlet line, wherein here advantageously only the lines in which incompressible fluids are guided are observed.

Overall, it is desirable to operate the cleaning system in a lasting and energy-efficient manner. Therefore, it can be provided in a further improved embodiment that a heat recovery unit is provided which includes at least one heat exchanger, especially a heat exchanger of the draining cleaning fluid as an energy source.

As the cleaning fluid has an increased temperature in many cleaning methods, especially above 40° C. up to 70° C., the cleaning fluid to be fed in can be raised to an increased energy level before heating to the necessary process temperature.

Also from sustainability aspects and environmental protection aspects, a further improvement can consist in the fact that a separation unit is included, especially a separation unit for solids from the cleaning fluid.

This can mean either a recovery of solid ingredients from the cleaning fluid, which are either disposed of or recycled in an ordered manner or the treated cleaning fluid, in particular when it is pure water, can be used for further cleaning cycles and/or as process water for the production of pulp as starting material for the production of workpieces.

It is self-evident to the person skilled in the art that known methods and devices for the treatment of wastewater and/or chemical cleaning agents can be integrated.

In a further improved embodiment, it can be provided that a heating device is provided upstream of the cleaning unit, especially a heat exchanger and/or a heating device designed as a steam injection unit.

The heating device is integrated into the inlet line for the cleaning fluid in particular, but can also be integrated into a storage tank for one or more cleaning fluids. Here, all known heating systems and heating devices can be provided for the direct or indirect heating of the cleaning fluid.

In a further improved embodiment, an automated transfer system may be provided, by means of which
at least parts of the cleaning unit can be supplied and removed in a fully or partially automated manner and/or
the cleaning unit can be at least partially assembled for the intended use.

The transfer system can consist entirely or partially of a fully or partially automated robot system, which, for example, carries out the tightening and/or joining in a sensor-controlled manner, such as, for example, the selection and the transport of the closure frame suitable for the molding tools and/or the attachment of the connecting lines. The transfer system can be installed locally, as a fixed unit, or be mounted and/or movable in a mobile manner.

In a further improved embodiment, provision can be made for two cleaning units to be provided which, independently of one another, can each include and clean a molding tool and/or a pair of complementary molding tools, in particular can clean in the case of different process conditions.

In this way, it is possible, for example by means of separating closure elements or at two pressing stations, to carry out cleaning methods that depend on the molding tool and/or the degree of contamination. For example,
a first cleaning method can be carried out in a pre-pressing station with the two complementary molding tools there, and
a second cleaning method can be carried out in a hot pressing station with the two complementary (hot) molding tools there.

The two purification processes can differ, for example, in terms of duration, media (water, acid, alkaline solution) and process conditions (temperature, pressure, pressure profiles, etc.).

In a further improved embodiment, the cleaning system can include or be connectable to a control unit which is connected to at least one sensor of the cleaning system, and wherein the cleaning system and/or at least one cleaning method can be controlled and/or regulated at least temporarily by means of the data detected by the sensor.

In this case, the cleaning system is controlled and regulated in particular on the basis of sensor data which directly or indirectly depict the cleaning line and/or the cleaning progress. For example, a conclusion can be drawn about the available flow cross section via the pressure drop and from the inlet line arranged at the inlet to the drain line and thus to the progress of the cleaning. Alternatively or additionally, a conclusion can be drawn on the cleaning progress via the volume flow of the cleaning fluid in combination with the line recording of the pump or the conveying and pulse unit. In this case, further sensor data can be evaluated, for example the turbidity of the cleaning fluid in the drain line and/or in the separation unit.

It can thus be advantageous to use a KI-based software, which evaluates one or a plurality of detection data and provides said data to the control unit, for the direct or indirect control of the cleaning method. This provision can be carried out in a fully automated manner or by an indication of an operator.

In a further embodiment, it is advantageous to provide an optical detection unit by means of which the surface contacting the workpiece can be detected.

In this way, an optical detection by means of, for example, a camera and/or a laser scanner can be carried out before and/or after each cleaning by the molding tool and these optical detection data can be used by a KI-based evaluation software and/or used by the controller directly for the cleaning method and/or the manufacturing method.

In a further improved embodiment, the cleaning system can include or be connectable to a control unit which is connected to sensors and/or an evaluation unit of a manufacturing device, and wherein said data of the manufacturing device relate to at least one process condition of the manufacturing process and are usable for the operation of the cleaning system and at least one cleaning element.

The control device of the cleaning system can be completely or partially identical to the control device for the manufacturing device.

Process-related or process-relevant data which are relevant to the operation of the cleaning system can be, for example, the pressure and pressure profiles over time, in particular an excessive pressure increase for ejecting the workpieces from a molding tool can be an indicator of highly soiled openings in the mold parts. Likewise, in a group of workpieces which are formed in the same way, a non-uniform distribution of the masses or fluctuations in the surface topography can be an indication of completely or partially soiled openings in the mold parts.

Furthermore, a conclusion concerning the cleaning requirement can be obtained from the power consumption of units, for example during the suction of fiber material from a pulp and the amount of fiber absorbed over time. This can optionally take place in combination with the weighing data of the workpieces after final weighing during final inspection.

With regard to the identification of cleaning demand with respect to the time, duration and/or the type of cleaning, it can also be advantageous if a KI-based evaluation software is applied in the control unit and this control unit is designed for use of a KI-based evaluation software and/or the control unit is designed to cooperate with a KI-based evaluation unit.

The disclosed embodiments further include a manufacturing device for workpieces. The manufacturing device has a forming unit and can be connected to a material feed unit and a diverting unit or have these units.

In this case, the forming unit has at least one of the following stations:
a preforming station with at least one preforming tool and/or
a pressing station with at least one pressing device,
   wherein at least one molding tool is held at one of the stations and can be moved by the latter by motor drive, and wherein at least one control unit is provided. In this case, for cleaning the at least one molding tool, a cleaning system with at least one cleaning unit is provided, which cleaning system is designed according to one of the above-mentioned embodiments and embodiment variants.

The at least one molding tool is a suction and/or preforming tool of the preforming station and/or a pressing tool of the at least one pressing device, in particular the molding tool of a hot-pressing device.

The control unit is used in particular for controlling and regulating units, actuators, devices and the like and receives detection data from at least one sensor.

In this case, a sensor is understood to mean any detection unit which, as an integral unit, determines measured values and forwards them directly or in processed form as measurement data (also referred to as detection data), or a detection unit in a larger unit, such as, for example, a sensor integrated in a motor, which detects, processes as required and forwards count values, consumption or other power or process data.

In a further improved embodiment of the manufacturing device, it can be provided that the forming station and/or the pressing device is designed so as to be movable in such a way that at least parts of the cleaning unit can be removed from a storage store and/or connected thereto.

The pressing device can be pivotably mounted in such a way that a removal of closure frames, which are designed for corresponding molding tools, can be achieved from a storage store arranged adjacent to the transport and production line, in which one or more closure frames are provided, and the molding tool can be (automatically) coupled with the closure frame.

Alternatively, provision can be made for a storage store to be mobile and movable. This may be coupled to a fixed travel path or track. Alternatively, a freely movable storage store can be provided, which is arranged, for example, on an autonomous means of transport.

The disclosed embodiments further include a cleaning method for a manufacturing device. This cleaning method including the steps of:
stopping the manufacturing device and/or the production method for workpieces,
opening the at least one molding tool or moving the molding tool into an open position.

This is followed by the following steps and phases:
installation step of the cleaning unit and
cleaning step, comprising a flow of at least one cleaning fluid through the cleaning unit for a defined period of time, and
removal step of the cleaning unit.

The flow is carried out in particular under an elevated pressure which can be different for the duration of the flow. The flow is carried out through at least one interior of at least one molding tool and the openings of the mold parts into the drain space and subsequently the cleaning fluid is discharged from the drain space via a drain connection.

In the installation step, essentially one or both molding tools are connected to a closure frame and the cleaning unit is closed in a fluid-tight manner or pressed against one another in such a way that it is closed in a fluid-tight manner. Furthermore, all required media connections are made in the installation step, especially for the introduction of the cleaning fluid and the discharge thereof.

In an analogous manner, the removal step is the return or removal of the closure frame and the restoration of the initial situation, so that production of workpieces can be carried out.

All in all, all aspects and advantages which have been expressed for the cleaning system, the manufacturing device or the cleaning method also apply directly or in an analogous manner to the other category in each case and vice versa.

In the present context, “opening of the molding tool” is not to be understood restrictively and means any position of the molding tool in which the installation step or the removal step can be carried out, in particular in which a closure frame can be attached or removed.

An improvement can consist in the fact that the flow is carried out in at least two phases (cleaning phases):
soaking phase for a first defined duration (dt1) at at least a first pressure (p1) and
pulse phase for a defined duration (dt2) with at least one pressure pulse at a second pressure (p2) for at least one defined pulse duration (dtₚ), wherein the second pressure (p2) is greater than the first pressure (p1).

Advantageously, the first pressure (p1) is in the range from 0.5 to 2 bar and the second pressure (p2) is in a defined pulse duration in the range from 4 to 10 bar. Furthermore, it has been found to be advantageous if the soaking phase is in the range of (t1) 2-10 Min and the pulse phase (dt2) is in the range of 1 to 5 Min. The pulse duration (dtₚ) is ideally in the range from 1 to 5 sec.

The number of pressure pulses in the pulse phase depends on the degree of contamination and must be provided as required. However, it has been found that 2 to pressure pulses are sufficient at all degrees of contamination, in particular 3 to 6 pressure pulses are sufficient.

In this context, the pulse phase means the initiation or triggering of macro impulses, with possibly the aforementioned pulse duration (dtₚ), which is to be distinguished from a cleaning step using ultrasound step in which micro pulses are caused.

A further improvement may be that the cleaning fluid has
a first temperature (T1) in the soaking phase, and
a second temperature (T2) in the pulse phase, wherein the first temperature (T1) and the second temperature (T2) can be different.

In this case, the first temperature (T1) is advantageously in the range from 30° C. to 90° C., ideally in the range from 50° C. to 70° C. The second temperature (T2) is advantageously in the range from 15° C. to 70° C., ideally in the range from 15° C. to 50° C. It has been found that, in the pulse phase, there is no significant soaking over an increased temperature, but the fluid-mechanical effect is in the foreground, so that a temperature reduction and thus energy saving are initiated.

In the case of a further improved method variant, it can be provided that, after the soaking phase and/or the pulse phase, a rinsing phase for a defined third duration (dt3) is carried out at a third temperature (T3) and/or a third pressure (p3), wherein in the rinsing phase an identical rinsing fluid to the cleaning fluid or a different rinsing fluid is used, especially water, as a rinsing fluid.

It goes without saying that, depending on the need for cleaning, the aforementioned cleaning phases can be repeated or extended completely or partially as required.

In the case of a further improved method variant, it can be provided that a first monitoring phase for detecting the degree of soiling is included in which—the requirement for performing a cleaning method and/or
the requirement for the intensity of a (time) later cleaning method
   is carried out by detecting process data, in particular the cleaning method is started, terminated and/or performed partially or fully automatically depending on the detected and evaluated process data.

In this case, in the case of an advantageous monitoring phase, a distinction can be made or determined by means of sensors during operation of the manufacturing device which molding tools have the cleaning requirement and are determined on the basis of this of the start time, the type of cleaning and the cleaning duration.

In addition to the aforementioned detection data from absolute pressures, pressure profiles, hoses etc., the demand for cleaning can also be estimated, for example, from optical data such as image data or topographic data from the molding tool or the workpieces in the end formations or a preform of the molding.

In a further improved process variant, it can be provided that the process data (acquisition data) indicating the degree of contamination can be
primary process data of the manufacturing device and/or the manufacturing process for the workpieces, which relate in particular to chemical, physical and/or electrical values of process media and/or energy quantities and/or
secondary data, which relate to chemical, physical and/or electrical values of the device of the manufacturing device and/or the manufacturing plant.

Therefore, the primary process data represent, in particular, acquisition data describing process media, the workpiece itself, and consumptions, and include the following values:
volume flow, e.g., during blow-off/blow-off process
pressure difference, e.g., during blow-off
turbidity of fluids, esp. discharge fluid during pressing and/or suction
electrical conductivity of fluids
temperature, e.g., of the extracted water vapor
in the pre-press/hot press
power consumption of conveying units, esp. compressor, vacuum pump,
   in particular as a function of further primary process data, such as volume flow and/or pressure/pressure drop
weight/mass consumption of the workpieces/group of workpieces
   per time unit/forming step
temperature of a workpiece
moisture (content) of a workpiece after forming
filling level of receiving tanks and/or availability of process media

In particular, the secondary data represent acquisition values that describe an aggregate or a component itself in its state and include the following values:
surface temperature
vibration and/or sound emission
speed
frequency and/or duration of use

In a further improved method variant, it can be provided that a second monitoring phase is included in which cleaning process data are detected and evaluated after the start of the cleaning method and/or the cleaning step, in order to determine the need for the execution, in particular the continuation, of the cleaning method, the cleaning method being controlled and/or regulated, in particular partially or fully automatically, as a function of the detected and evaluated cleaning process data.

The aspects of the second monitoring phase are analogous to the first monitoring phase and relate to the cleaning method itself and its progress, i.e. the duration, also the duration of individual cleaning phases and the type, for which purpose the selection of the process media, process parameters, cleaning media and also the use of, for example, ultrasound.

In a further improved method variant, it can be provided that the cleaning process data include primary and/or secondary cleaning process data.

Primary cleaning process data in particular represent detection data which describe media for the cleaning method and its consumption, such as the following values:
volume flow, e.g., during blow-off/blow-off process
pressure difference or pressure curve over in the inlet flow line,
   the interior and/or the drain line
turbidity and/or solids content of a cleaning fluid,
   in particular of the outflowing or returning cleaning fluid
electrical conductivity of cleaning fluid(s)
temperature of a fluid, such as
   for example, of the extracted water vapor,
power consumption of conveying units,
   in particular of pump, compressor or vacuum pump,

Overall, it can be advantageous to evaluate the primary cleaning process data in dependence on, in multiple dependence and/or on the basis of further primary cleaning process data.

The secondary cleaning process data represent, in particular, detection values which describe an aggregate or a component itself in its state which are integrated directly or indirectly during the cleaning method and include the following values:
surface temperature
vibration and/or sound emission
speed
frequency and/or duration of use

In a further improved process variant, it can be provided that at least one supply and/or one receiving tank is provided for each cleaning fluid, in particular a supply and/or a receiving tank for a cleaning fluid which is
water or an aqueous cleaning fluid,
a recycled cleaning fluid,
a cleaning acid, especially citric acid, acetic acid, phosphoric acid
a cleaning lye, esp. NaOH and/or
a cleaning solution comprising at least one surfactant and/or
a disinfectant, such as H2O2, peracetic acid, fungicide, herbicide etc.

The control and regulation of the different inlets and outlets takes place via known valve units, connections and control and regulation known for this purpose.

In a further improved method variant, the soaking phase and/or the pulse phase can include at least one physical cleaning step, wherein the physical cleaning step is in particular
a mechanical cleaning step using at least one drivable cleaning part or group of cleaning parts and/or
an ultrasonic cleaning step.

The physical purification step can also take place at the beginning or at the end of one of the cleaning phases or the rinsing phase.

In an advantageous embodiment of the method, movable cleaning elements, the cleaning parts of which are brushes, sponges or the like, are contacted and driven relative to the mold parts with at least a portion of the surface of the mold parts. This drive can advantageously be designed as a hydraulic drive. This hydraulic drive can be an impeller wheel which is illuminated by means of at least one ejector or a nozzle and is set in Rotation, while the cleaning parts contact the mold part.

In a further improved method variant, it can be provided that the cleaning process data determined in the cleaning step are conducted to an evaluation unit, wherein the evaluation unit guides the completely or partially conditioned data from the cleaning process data to a control unit.

The control unit controls based on the conditioned data and using and/or integrating other detection data, target value specifications, especially algorithms, value tables and/or a KI-based evaluation software. By means of the control, motors, assemblies and other control elements are at least temporarily controlled and/or regulated in a basically known manner, whereby information and/or warning signals are also included in an output unit which are transmitted, especially to an HMI (Human Machine Interface) and/or a signal generator.

Overall, it is advantageous if the cleaning method is used for a manufacturing device which is designed according to one of the above-described embodiments and embodiment variants.

Furthermore, it can be advantageous if a cleaning system and/or a cleaning unit which are designed according to one of the above-described embodiments and embodiment variants is used during the cleaning method.

Further details and advantages of the disclosed embodiments will now be explained in more detail with reference to an exemplary embodiment illustrated in the drawings.

### BRIEF DESCRIPTION OF THE DRAWINGS

In the drawings:

FIG. 1 shows a schematic sectional drawing of the cleaning unit in an embodiment.

FIG. 2 shows a schematic sectional drawing of the cleaning unit in a second embodiment.

FIG. 3 shows a schematic sectional drawing of the cleaning unit in a third embodiment.

FIG. 4 shows a schematic sectional drawing of the cleaning unit in a fourth embodiment.

FIG. 5 shows an embodiment of the cleaning unit in a manufacturing device.

FIG. 6 schematically shows the phases of the cleaning step in an embodiment.

FIG. 7 shows a schematic sectional drawing of the cleaning unit in a fifth embodiment.

### DETAILED DESCRIPTION

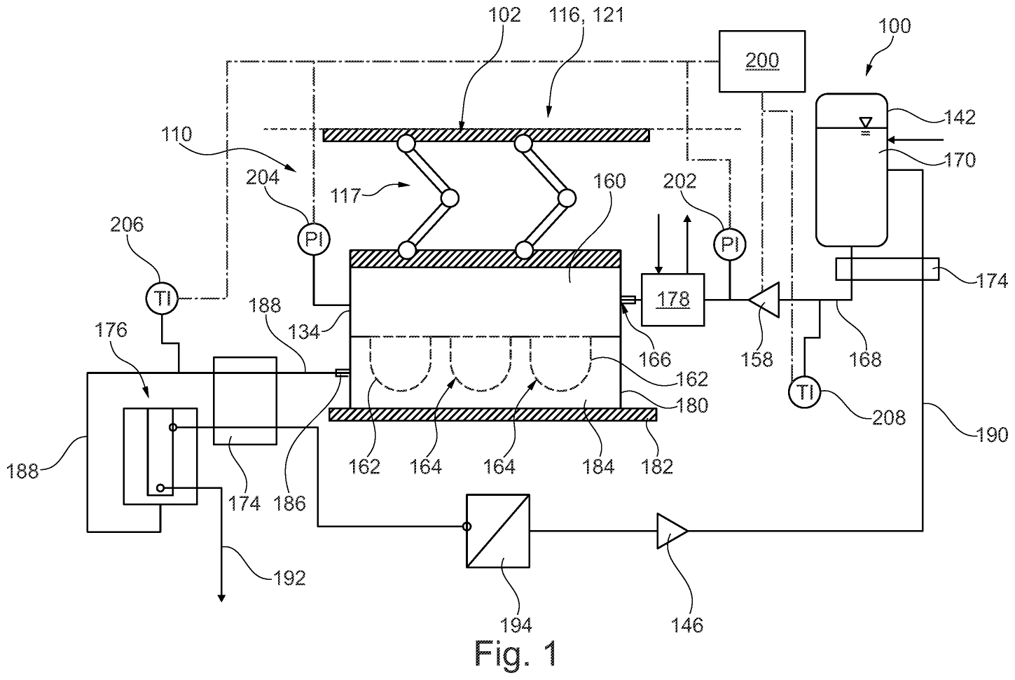

FIG. 1 shows a schematic structure of a cleaning system 100 with a cleaning unit 110 for a forming unit 121, not shown, for workpieces made of fibers or a fiber-containing starting material. The cleaning unit 110 is secured to a support and holding structure 102 by a motor-driven pressing device 117.

The cleaning unit 110 includes:
a molding tool 134 arranged above, which has a flow-through interior 160 and a group of positive mold parts 162, three of which are shown in section. The mold parts 162 have a type of mesh structure or screen structure with many small openings,
a closure frame 180, and
a closure element 182.

An inlet connection 166, which is connected to the inlet line 168, is arranged on the molding tool 134. The inlet line 168 connects the storage tank 142 to the molding tool 134. A conveying and pulse unit 158, a pressure sensor 202 and a heating device 178 are integrated in the inlet line 168.

Furthermore, a drain connection 186 is arranged on the closure frame 180, which outlet connection is connected to a drain line 188. Drain line 188 connects drain space 184 or closure frame 180 to a downstream separation unit 176, which has a return line 190 for a liquid phase and a discharge line 192 for solids or sludge on the outlet side. The return line 190 connects the separation unit 176 to the storage tank 142 for the cleaning fluid 170, wherein a filter unit 194 and a pump 146 are arranged downstream of the separation unit 176.

Furthermore, two heat exchangers 174 are integrated in the outlet. The first heat exchanger 174 energetically connects the drain line 188 downstream of the drain connection 186 to the return line 190 downstream of the separation unit 176 and the second heat exchanger 174 energetically connects the return line 190 to the inlet line 168.

In the example shown, four sensors are shown by way of example. Pressure sensor 202 in the inlet line, a pressure sensor 204 on the molding tool 134 or in its interior 160 and a temperature sensor 206, 208 in the inlet line 168 and in the drain line 188.

The sensors and the assemblies, such as the feed and pulse unit 158, the pump 146 and the pressing device 117 are connected to the control unit 200, as indicated by means of dot-dash lines. It is understood by the person skilled in the art that for simplification the plurality of usual and required components, assemblies, actuators, valves, sensors and other elements are not shown and must be provided if necessary.

FIG. 1 shows the cleaning unit 110 in the closed state, in which the pressing device 117 exerts a force in the vertical direction on the molding tool 134, the closure frame 180 and the plate-like closure element 182, sealing them against each other in a fluid-tight manner. The lower closure element 182 is placed on a table or base plate (not shown) and guides the forces of the molding tool used as a pressing tool in this way.

The cleaning process is carried out in the context of known and predefined conditions and/or process parameters. In the present case, further monitoring of the progress of cleaning takes place by monitoring the pressure profile over time and the necessary line recording of the feed and pulse unit 158 in the soaking phase and/or in the pulse phase. With progressive cleaning success, an ever larger flow cross section is made available to flow through the openings 164 in the mold parts 162, which flow cross section asymptotically approaches a limit value. This limit value of the flow cross section is ideally identical to that of the new or completely cleaned mold parts 162.

This ideal flow cross section correlates with the volume flow, the pressure and/or the required power consumption of the feed and pulse unit 158, which in the example shown is a piston pump.

Therefore, a conclusion can be drawn indirectly about the actual flow cross-section, which is actually unknown during the cleaning method, and the actual cleaning condition inside, via the aforementioned acquisition data, and controlled accordingly.

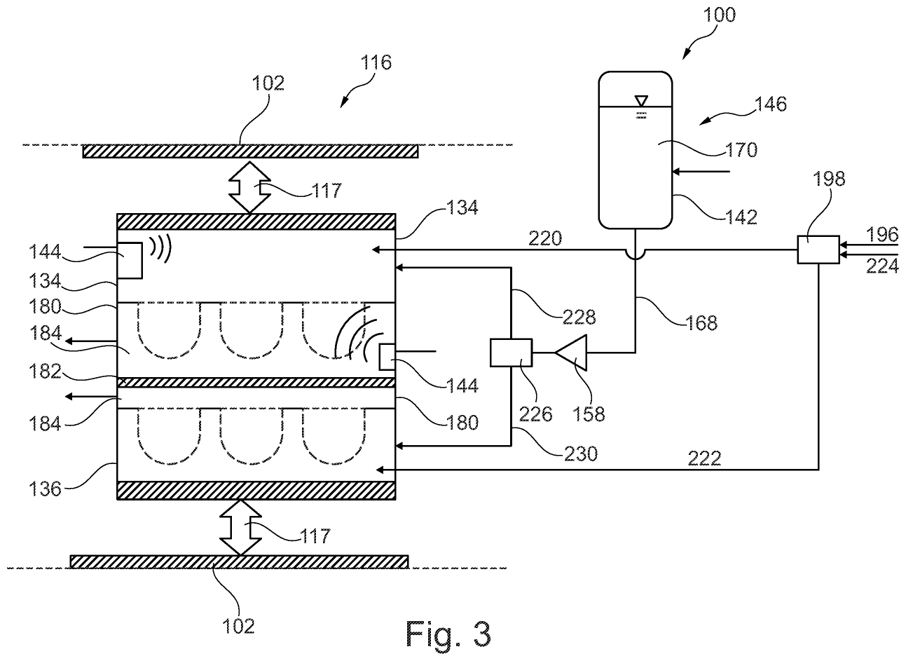

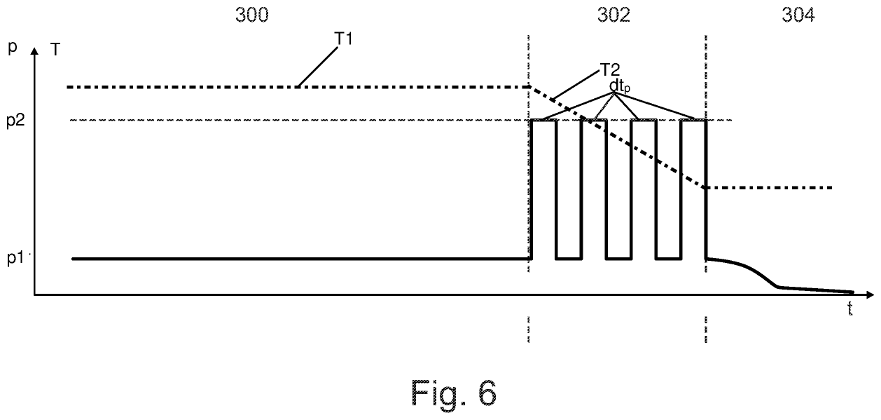

If, for example, the line pickup of the conveying and impulse unit 158 after completion of a standard pulse phase 302 (FIG. 6) is higher by an unacceptable degree than with a completely cleaned or new molding tool 134, the pulse phase 302 can be extended or an ultrasound emitter 144 (FIG. 3) can be activated for a period of time, in particular to loosen particularly stubborn buildup.

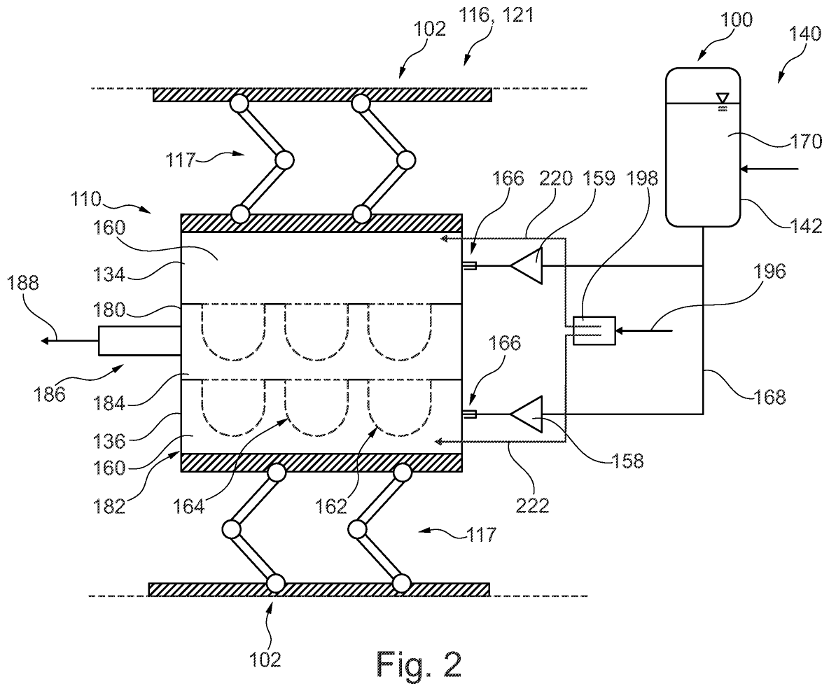

FIG. 2 also shows the cleaning unit 110 in a closed state, analogous to FIG. 1, in which two driven pressing devices 117 exert a force from two directions in the vertical direction on the upper molding tool 134, the closure frame 180 and the lower molding tool 136, closing them against each other in a fluid-tight manner.

In this embodiment, the lower molding tool 136 forms the closure element 182 for the upper molding tool 134 and vice versa. In other words, the two molding tools 134, 136 are opposite each other and close one another or the enclosed drain space 184.

Each molding tool 134, 136 has an inlet connection 166, which is connected to the inlet line 168 and thereby to the storage tank 142 for the cleaning fluid 170. The closure frame 180 is analogous to that of FIG. 1 and may be connected analogously to a drain line 188.

In contrast to FIG. 1, a delivery and pulse unit 158, which is designed as a positive displacement pump, is provided in each inlet line 168. In addition, a steam inlet line 196 is arranged upstream of the molding tools 134, 136 and leads via a valve unit 198 to two fluid lines 220, 222, of which each is connected to an interior 160 of a molding tool 134, 136. In this embodiment, pressure pulses can be caused from a steam accumulator (not shown) via a steam expansion from the valve unit 198, which are independent of the two feed and pulse units 158.

In the embodiment shown in FIG. 3, the basic structure is analogous to FIG. 2, with a central closure element 182 being provided, on which a closure frame 180 is arranged above and below in each case, so that a drain space 184 is formed on each side of the closure element 182, both of which have different volumes. The upper drain space 184 is larger because it has to absorb the positive mold parts 162 and the lower drain space 184 is smaller because the negative mold parts 162 protruding into the interior 160 do not require an additional volume.

Furthermore, a common conveying and pulse unit 158 is provided and a valve unit 226 located downstream for this purpose, in which the inlet line 168 can be divided into two partial feed lines 228, 230. A steam inlet line 196 and a gas inlet line 224 lead into the valve unit 198. The steam inlet line 196 may be identical to that shown in FIG. 2. The gas inlet line 224 is in particular a compressed air line and can serve to blow out the interiors and/or to selectively carry out pressure measurements in order to measure the cleaning course. Each fluid line 220, 222 connects the valve unit 198 to an interior 160 of a molding tool 134, 136.

In addition, an ultrasound emitter 144 is integrated in or on the wall in the interior 160 of the upper molding tool 134 and in the upper closure frame 180, and these can additionally or alternatively also be provided for the lower molding tool 136.

In this embodiment, there is a great advantage that the upper molding tool 134 can be cleaned independently of the lower molding tool 136, which in particular relates to the duration and intensity. For example, if the progress of the cleaning of the individual molding tools 134, 136 is monitored in the manner described, the cleaning method for the lower molding tool 136 may be finalized while the upper molding tool 134 continues to be cleaned and/or at different process conditions. This can also consist in the fact that a cleaning step is additionally carried out by means of activation of the ultrasound emitter 144.

The valve unit 226 can also form a pulse unit together with the feed and pulse unit 158 if a correspondingly high pressure is provided, for example, from 4 to 6 bar on the pressure side of the feed and pulse unit 158, which is discharged via valves of the valve unit 226 accordingly as a pressure pulse for 1 to 2 seconds in each case.

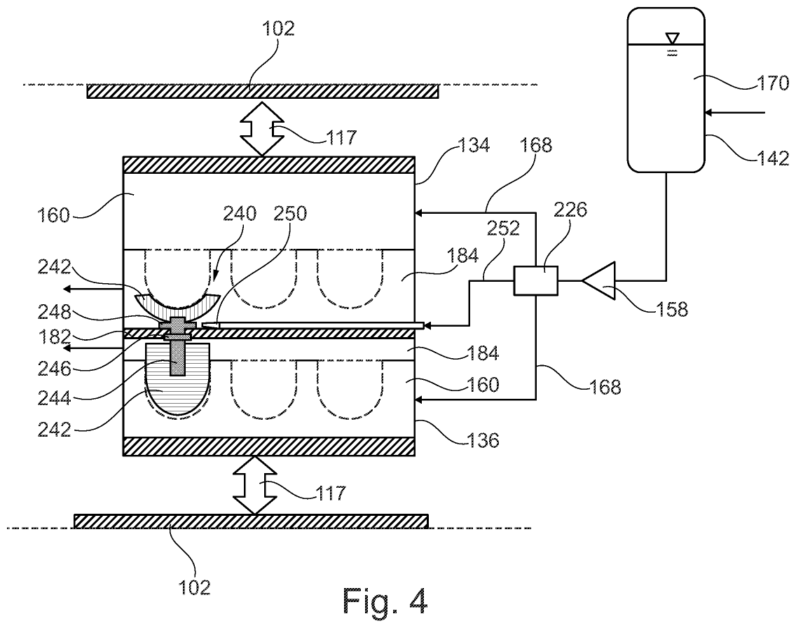

The cleaning unit 110, as shown in FIG. 4, is constructed analogously to FIG. 3 and has a central closure element 182, therefore the previous explanations apply in an analogous manner. In this case, “centrally” is not to be understood in the mathematical sense, but merely describes a central position of a sequence of elements in the sense shown.

In the embodiment shown, the closure element 182 serves as a bearing plate for rotatably arranged cleaning elements 240. These cleaning elements 240 have cleaning parts 242 which are adapted to the outer contours of the mold parts 162 and are designed as brushes. FIG. 4 shows only one exemplary cleaning element 240 with associated components. In the ideal case, a cleaning element 240 is provided for each mold part or pair of complementary mold parts 162.

The vertically aligned shaft 244 of the cleaning element is guided through the closure element 182 and is mounted in a bearing 246 there, which ideally is a plain bearing. An impeller wheel 248 is disposed on the shaft 244 and can be selectively driven by an ejector 250. The driving fluid may be, for example, a partial flow of the cleaning fluid 170 or compressed air, as in the example shown, which is supplied to the ejector 250 via the valve unit 226 and the feed line 252.

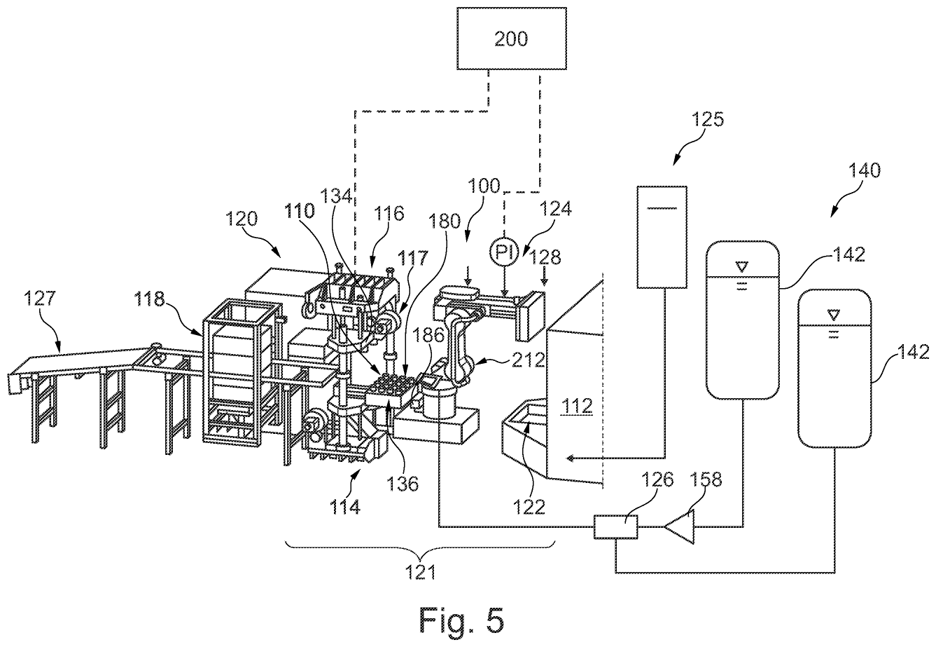

FIG. 5 illustrates one embodiment of the cleaning system 100 and cleaning unit 110 in connection with a manufacturing device 120 for manufacturing workpieces from a fibrous material.

The manufacturing device 120 includes a preforming station 112, a first pressing station 114, a second pressing station 116, a finishing unit 118 and a diverting conveyor 127. A receiving tank 122 is included as part of the preforming station 112. The first pressing station 114 includes a robot unit 124, on which a suction tool 126 forming and/or pre-pressing the workpieces is arranged and guided. Alternatively, the robot unit 124 may be a robot unit 124 common to the preforming station 112. The finishing unit 118 can include one or more functions, as required, such as coating, cutting, stacking and/or packaging. The workpieces or workpiece stacks finished in this way are discharged via the diverting conveyors 127.

For the preforming of workpieces, the suction tool 126 is lowered into the receiving tank 122 filled with a pulp containing fiber material as the aqueous phase, and a defined layer of moist fiber material is sucked onto the contour of the screen-like suction tool 126 by means of the vacuum pump 123. The suction tool 126 here is the preforming tool. A pressure sensor 210 is provided in the line between the vacuum pump 123 and the suction tool 126, via which a degree of contamination can be detected in an analogous manner, in particular in the synopsis and correlation with the line pickup of the vacuum pump 123, which can be detected via an integrated sensor 212. Part of the liquid phase is already extracted and discharged in the suction tool 126 or in the preforming station 112. Subsequently, this defined layer is dewatered and pre-pressed in the first pressing station 114, wherein the workpieces 150 do not leave the suction tool 126 and are held there in particular under vacuum. This pre-pressing takes place at a temperature in the range from 30° C. to 80° C. and a pressure in the range from 0.2 N/mm² to 0.3 N/mm². Subsequently, after the preformed workpieces have been passed over into a hot-pressing tool, the molding tool 136, a second pressing station 116, takes place the final formation of the workpieces 150. This second pressing station 116 is in this case designed as a main or hot-pressing station and the workpieces 150 are transferred from the suction tool 126 by means of a compressed air pulse into one of the pressing tools 134, 136. This is generally the lower molding tool 136.

Forming in the second pressing station 116 takes place at a (main) pressure in the range of 0.5 N/mm² to 2.0 N/mm² and a temperature of 100° C. to 250° C. to 250° C. This process is known in principle. In a variant of the method, which is not shown, the final forming of the workpieces takes place in a single hot and pressing step, which is generally energetically however very complicated.

Furthermore, a control unit 200 is provided which, in a manner not shown in more detail, acts on the manufacturing device in a controlling and regulating manner and receives and evaluates detection data from the sensors and sensor units.

FIG. 5 shows the cleaning unit 110 of the cleaning system 100 in the installation step, while the other manufacturing device 120 is switched off. The cleaning system 100 includes a storage station 140 which includes two storage tanks 142 for different cleaning fluids 170 and can be connected to the inlet connection 166 via a conveying and pulse unit 158 and a valve unit 226.

The closure frame 180 is placed on the lower molding tool 136 and the drain connection 186 is not yet connected to a drain line 188 (not shown). Furthermore, the upper molding tool 134 is moved by means of the pressing device 117 into an open position, which in the present case is the uppermost possible position.

The lower molding tool 136 is displaced to the left with the closure frame 180, the upper molding tool 134 is lowered and the cleaning unit 110 is thus closed in a fluid-tight manner and can be cleaned after the connection of all inlet and drain lines in the second pressing station 116.

FIG. 6 shows a schematic representation of the cleaning phases. After the installation step, the purification step begins with a soaking phase 300 which takes place at an elevated first pressure p1 of about 0.5 to 1 bar, wherein the temperature T1 of the cleaning fluid is about 70° C. The increased pressure p1 serves substantially to maintain the flow. In this case, the loose adhesions are discharged and the stronger deposits are softened.

The soaking phase 300 is followed by a pulse phase 302 in which, in the example shown, discrete pressure pulses for a pulse duration dtₚ from 3 to 5 sec. and the second pressure p2 of about 6 bar are introduced. The temperature T2 in the pulse phase can be below that of T1, in particular the heating device 178 can be switched off in the pulse phase 302 and the temperature has an unregulated profile. The heating device 178 can be any suitable heating device, in particular an electrical heating device or a heating device by means of direct steam feed. In the example shown, soaking phase 300 and pulse phase 302 last 15 Min, wherein the soaking phase 300 takes ⅔ of the time.

The pulse phase is followed by a conversion phase 304, in which the cleaning unit 110 is emptied, rinsed and removed as required, so that the manufacturing device is ready for operation below.

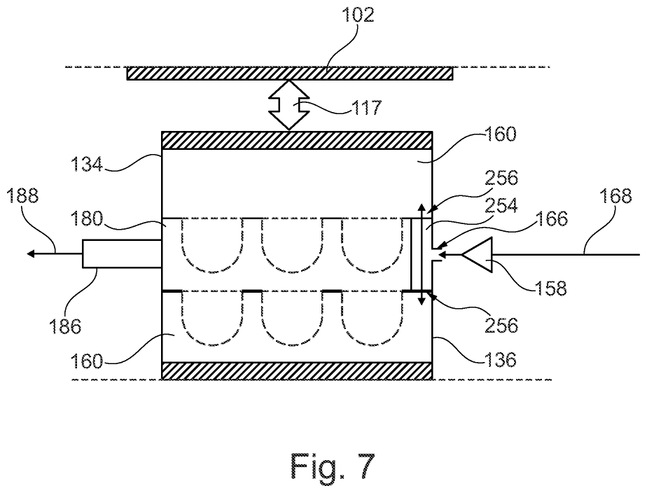

Finally, FIG. 7 shows a structure of the cleaning unit 110 that is comparable to that shown in FIG. 2. In contrast to this, the molding tools 134, 136 do not have any external inlet connections. The closure frame 180, on the other hand, has an inlet connection 166 which, in the interior, merges into a connecting line 254 and establishes an, in particular pluggable, connection to the two interiors 160 via quick coupling connections 256. Due to the pressure profiles prevailing in the cleaning process, the quick coupling connections 256 do not have to be complex and can be simple, not specially sealed and/or form-fitting geometries. However, for the function of the molding tool 134, 136 during the forming of workpieces, it is necessary for the part of the quick coupling connection 256 to have a closure element in or on the molding tool 134, 136, in particular an automatically switching closure element which is opened only in the connection with the closure frame 180 and/or process parameters of the cleaning method.

The particular advantage is that the closure frame 180 can already be guided up with all required connections and/or can be mounted without the connections being released.

Overall, it is understood that the information related to gravity or the representation such as “(from) top”, “above”, “(from) below”, “below”, “center”, “to the left”, etc. are not to be understood as limiting and only serve to describe the image. In particular, the pressing device 117 and the cleaning unit 110 can be in any orientation, even if the vertical orientation, as shown, is frequently very advantageous for the force dissipation.

Furthermore, the elements and features of the different embodiments in FIGS. 1 to 4 and 7 in particular can be combined as required. In particular, the elements for processing, energy coupling and/or feedback can also be used in a suitable, analogous manner in other exemplary embodiments.

The following numbered clauses set out various non-limiting embodiments disclosed herein:

A1. A cleaning method for a manufacturing device, comprising the steps of:
stopping the manufacturing device,
opening the at least one molding tool,
wherein at least the following steps and phases follow:
installation step of the cleaning unit, and
cleaning step, comprising a flow of at least one cleaning fluid through the cleaning unit for a defined period of time under elevated pressure, and
removal step of the cleaning unit.

A2. The method according to any previous clause within set A, wherein the flow is carried out in at least two phases:
soaking phase for a first defined duration (dt1) at at least a first pressure (p1), and
pulse phase for a defined duration (dt2) with at least one pressure pulse at a second pressure (p2) for at least one defined pulse duration (dtₚ), wherein the second pressure (p2) is greater than the first pressure (p1).

A3. The method according to any previous clause within set A, wherein the cleaning fluid has:
a first temperature (T1) in the soaking phase, and
a second temperature (T2) in the pulse phase, wherein the first temperature (T1) and the second temperature (T2) can be different.

A4. The method according to any previous clause within set A, wherein, after the soaking phase and/or the pulse phase, a rinsing phase is carried out for a defined third duration (dt3), at a third temperature (T3) and/or at a third pressure (p3), wherein in the rinsing phase an identical rinsing fluid to the cleaning fluid or a different rinsing fluid is used as a rinsing fluid.

A5. The method according to any previous clause within set A, wherein a first monitoring phase for detecting the degree of soiling is included in which
the requirement for performing a cleaning method and/or
the requirement for the intensity of a (time) later cleaning method
   is carried out by detecting process data, in particular the cleaning method is started, terminated and/or performed partially or fully automatically depending on the acquired and evaluated process data.

A6. The method according to any previous clause within set A, wherein the process data indicating the degree of contamination are:
primary process data of the manufacturing device and/or of the manufacturing process for the workpieces, which relate in particular to chemical, physical and/or electrical values of process media and/or energy quantities and/or
secondary data, which relate to chemical, physical and/or electrical values of the device of the manufacturing device and/or the manufacturing plant.

A7. The method according to any previous clause within set A, wherein:
the primary process data include the following values:
volume flow, e.g., during blow-off/blow-off process;
pressure difference, e.g., during blow-off;
turbidity of fluids, especially discharge fluid during pressing and/or suction;
electrical conductivity of fluids;
temperature, e.g., of the extracted water vapor
in the pre-press/hot press;
power consumption of conveying units, esp. compressor, vacuum pump, in particular as a function of further primary process data, such as volume flow and/or pressure/pressure drop;
weight/mass consumption of the workpieces/group of workpieces per time unit/forming step;
temperature of a workpiece;
moisture (content) of a workpiece after forming; and
filling level of receiving tanks and/or availability of process media and/or
the secondary data include the following values:
surface temperature,
vibration and/or sound emission,
speed and
frequency and/or duration of use.

A8 The method according to any previous clause within set A, wherein a second monitoring phase is included in which cleaning process data are detected and evaluated after the start of the cleaning method and/or the cleaning step, in order to determine the need for the execution, in particular the continuation, of the cleaning method, wherein, in particular partially or fully automatically, the cleaning method is controlled and/or regulated as a function of the detected and evaluated cleaning process data.

A9. The method according to any previous clause within set A, wherein the cleaning process data comprises primary and/or secondary cleaning process data, wherein:
the primary cleaning process data include the following values:
volume flow, e.g., during blow-off/blow-off process;
pressure difference;
turbidity and/or solids content of a cleaning fluid;
electrical conductivity of cleaning fluid(s);
temperature of a fluid and
power consumption of conveying units
and
the secondary cleaning process data include the following values:
surface temperature;
vibration and/or sound emission;
speed and
frequency and/or duration of use.

A10. The method according to any previous clause within set A, wherein at least one supply and/or one receiving tank is provided for each cleaning fluid, in particular a supply and/or a receiving tank for a cleaning fluid which is:
water or an aqueous cleaning fluid,
a recycled cleaning fluid,
a cleaning acid, esp. citric acid, acetic acid, phosphoric acid,
a cleaning lye, esp. NaOH and/or
a cleaning solution comprising at least one surfactant and/or
a disinfectant, such as H2O2, peracetic acid, fungicide, herbicide etc.

A11. The method according to any previous clause within set A, wherein the soaking phase and/or the pulse phase comprise at least one physical cleaning step, wherein the physical cleaning step is:
a mechanical cleaning step using at least one drivable cleaning part or a group of cleaning parts and/or
an ultrasonic cleaning step.

A12. The method according to any previous clause within set A, wherein:
the manufacturing device (120) is formed according to any of claim 15 or 16 and/or
the cleaning system (100) is formed according to any of claims 1 to 14.

### LIST OF REFERENCE SIGNS

100 Cleaning system
102 Support and holding structure
110 Cleaning unit
112 Preforming station
114 Pressing station, first (pre-pressing station)
116 Pressing station, second (main pressing station)
117 Pressing device
118 Finishing unit
120 Manufacturing device
121 Forming unit
122 Receiving tank
123 Vacuum pump
124 Robot unit, drive unit
125 Material feed unit
126 Suction tool
127 Diverting conveyor, diverting unit
128 Forming station
134 Molding tool
136 Molding tool
140 Storage station
142 Storage tank
144 Ultrasound emitter
146 Pump
160 Interior
162 Mold part
164 Openings
166 Inlet connection
168 Inlet line (fluid line)
170 Cleaning fluid
174 Heat exchanger
176 Separation unit
178 Heating device
180 Closure frame
182 Closure element
184 Drain space
186 Drain connection
188 Drain line
190 Return line
192 Discharge line
194 Filter unit
196 Steam inlet line
198 Valve unit
200 Control unit
202 Pressure sensor
204 Pressure sensor
206 Temperature sensor
208 Temperature sensor
210 Pressure sensor
212 Sensor
220 Fluid line
222 Fluid line
224 Gas inlet line
226 Valve unit
228 Partial feed line
230 Partial feed line
240 Cleaning element
242 Cleaning part
244 Shaft
246 Bearing
248 Impeller wheel
250 Ejector, nozzle
252 Feed line
254 Connecting line
256 Quick coupling unit
300 Soaking phase
302 Pulse phase
304 Conversion phase

1. A cleaning system comprising at least one cleaning unit for a forming unit for workpieces made of a starting material comprising fibers, comprising:
a support and holding structure for the cleaning unit;
at least one molding tool;
wherein the at least one molding tool comprises:
at least one interior through which a flow can pass, and
at least one mold part having a plurality of openings, and wherein:
a pressing device, by means of which a force can be exerted on the at least one molding tool, and wherein at least one inlet connection for an inlet line is provided on the at least one molding tool, via which inlet connection a cleaning fluid can be introduced into at least one interior of the molding tool and can be discharged via the plurality of openings of the mold parts,
wherein a closure frame and a closure element are provided, the closure frame being arranged between the at least one molding tool and the closure element and these together forming a drain space, and the closure frame and/or the closure element having a drain opening and/or a drain connection in order to drain off cleaning fluid, the pressing device being designed for non-positive and sealing closure of the drain space and being arranged in an operative manner.

2. The cleaning system according to claim 1, wherein the cleaning unit comprises two complementary molding tools, each of the two molding tools having at least one inlet connection for an inlet line, via which inlet connection a cleaning fluid is configured to be introduced into at least one interior of the respective molding tool and configured to be discharged via the plurality of openings of the at least one mold part, and both molding tools being equipped with
in each case a closure frame; and
in each case one or a common closure element and in each case forming a drain space.

3. The cleaning system according to claim 1, wherein the cleaning unit has two complementary molding tools, each of the two molding tools having at least one inlet connection for an inlet line, via which inlet connection a cleaning fluid is configured to be introduced into at least one interior of the respective molding tool and is configured to be discharged via the plurality of openings of the at least one mold part, and wherein the further molding tool functions as a closure element and the closure frame is arranged between the two molding tools.

4. The cleaning system according to claim 1, wherein the pressing device is at least partially identical to that pressing device by means of which workpieces are configured to be formed.

5. The cleaning system according to claim 1, wherein the pressing device is a mobile clamping and/or gripping unit.

6. The cleaning system according to claim 1, wherein the cleaning unit is comprised of at least one ultrasound emitter arranged on the closure frame and/or the molding tool.

7. The cleaning system according to claim 1, wherein a conveying and pulse unit is provided upstream of the cleaning unit by means of which the interior (160) of the molding tool (134, 136) and/or the inlet line (168) is configured to be subjected to a pressure surge and/or pressure pulse.

8. The cleaning system according to claim 1, wherein a heat recovery unit is provided which comprises at least one heat exchanger of the draining cleaning fluid (170) as an energy source.

9. The cleaning system according to claim 1, further comprising a separation unit for separating solids from the cleaning fluid.

10. The cleaning system according to claim 1, wherein a heating device is provided upstream of the cleaning unit.

11. The cleaning system according to claim 1, wherein an automated transfer system is comprised, by means of which:
at least parts of the cleaning unit are configured to be supplied and removed in a fully or partially automated manner; and/or
the cleaning unit is configured to be at least partially assembled.

12. The cleaning system according to claim 1, wherein two cleaning units are provided which, independently of one another, each comprise and clean a molding tool and/or a pair of complementary molding tools.

13. The cleaning system according to claim 1, wherein the cleaning system comprises or is connectable to a control unit which is connected to at least one sensor of the cleaning system, and wherein the cleaning system and/or at least one cleaning method is configured to be at least temporarily controlled and/or regulated by means of data detected by the at least one sensor.

14. The cleaning system according to claim 1, wherein the cleaning system comprises or is connectable to a control unit which is connected to sensors and/or an evaluation unit of a manufacturing device, and wherein these data of the manufacturing device relate to at least one process condition of a manufacturing process and are configured to be used for the operation of the cleaning system and at least one cleaning unit.

15. A manufacturing device for workpieces comprising a material feed unit, a forming unit, and a diverting unit, the forming unit having at least one of the following stations:
a preforming station with at least one preforming tool,
a pressing station with at least one pressing device,
wherein at least one molding tool is held at one of the stations and is configured to be moved by the latter by motor drive, and wherein at least one control unit is provided,
wherein for cleaning the at least one molding tool, a cleaning system with at least one cleaning unit is included.

16. The manufacturing device according to claim 15, wherein the preforming station and/or the pressing device are operable to be movable in such a way that at least parts of the cleaning unit are configured to be removed from and/or connected to a storage store.

17. A cleaning method for a manufacturing device, comprising the steps of:
stopping the manufacturing device,
opening at least one molding tool,
wherein at least the following steps and phases follow:
installation step of a cleaning unit, and
cleaning step, comprising a flow of at least one cleaning fluid through the cleaning unit for a defined period of time under elevated pressure, and
removal step of the cleaning unit.

18. The method according to claim 17, wherein the flow is carried out in at least two phases:
soaking phase for a first defined duration (dt1) at at least a first pressure (p1), and
pulse phase for a defined duration (dt2) with at least one pressure pulse at a second pressure (p2) for at least one defined pulse duration (dtₚ), wherein the second pressure (p2) is greater than the first pressure (p1).

19. The method according to claim 18, wherein the cleaning fluid has:
a first temperature (T1) in the soaking phase, and
a second temperature (T2) in the pulse phase, wherein the first temperature (T1) and the second temperature (T2) can be different.

20. The method according to claim 18, wherein, after the soaking phase and/or the pulse phase, a rinsing phase is carried out for a defined third duration (dt3), at a third temperature (T3) and/or at a third pressure (p3), wherein in the rinsing phase an identical rinsing fluid to the cleaning fluid or a different rinsing fluid is used as a rinsing fluid.
